(19) United States
(12) Patent Application Publication
(10) Pub. No.: US 2009/0098238 A1
(43) Pub. Date: Apr. 16, 2009

(54) INJECTION MOLD AND METHOD OF USING THE SAME

(75) Inventor: CHEN-HUI WU, Shindian (TW)

Correspondence Address: PCE INDUSTRY, INC.;ATT. Steven Reiss, 458 E. LAMBERT ROAD, FULLERTON, CA, 92835, US

(73) Assignee: Sutech Trading Limited, Tortola (VG)

(21) Appl. No.: 11/967,037

(22) Filed: Dec. 29, 2007

(30) Foreign Application Priority Data
Oct. 12, 2007 (CN) 200710202049.5

(51) Int. Cl. B29C 45/40

(52) U.S. Cl. 425/556

(57) ABSTRACT

An injection mold (20) includes a female mold (22) and a male mold (24). The female mold defines a recess portion (222) therein. The male mold includes a mold core (242) and defines at least one main injection canal (2425) therein. The mold core cooperates with the recess portion to form a cavity (26) communicating with the main injection canal and configured for shaping workpieces. The main injection canal includes an injecting hole (2426) and an ejecting hole (2427) communicating with the injecting hole. The ejecting hole has a size larger than that of the injecting hole and is positioned to be proximate to the cavity.

### BACKGROUND OF THE INVENTION

1. Field of the Invention

The present invention relates to injection molds, and particularly to an injection mold configured for fabricating workpieces made by means of injection molding and a method of using the same.

2. Description of Related Art

Nowadays, portable electronic devices such as mobile phones, laptops and personal digital assistants (PDAs) are widely used. Most housing of portable electronic devices are made of plastic. In fabrication, melted plastic is injected into an injection mold and concretes to form desired housings. Furthermore, designs configured for decoration are also often formed on the housings.

Referring to FIG. 9, a typical injection mold 30 configured for fabricating plastic housings with decorating designs includes a female mold 32 and a male mold 34. The female mold 32 defines a recess portion 322 therein. The male mold 34 includes a mold core 342 corresponding to the recess portion 322, and defines a plurality of injection canals 346 therein. In a typical process of making the plastic housings by using the injection mold 30, a film 42 is provided with a design 44 formed thereon. The design 44 is formed by applying ink or paint onto the film 42. The film 42 is placed into the injection mold 30 in such manner that one surface of the film 42 at an opposite side of the design 44 is attached to the bottom of the recess portion 322. The male mold 34 then covers the female mold 32 to form a cavity (not shown), and melted plastic is injected into the cavity via the injection canals 346. The plastic cools down to form a housing (not shown), the film 42 with the design 44 is then attached to the housing.

However, since the melted plastic has high pressure and temperature, the melted plastic may scour and cause damages to the design. Additionally, some parts of the housing that are formed adjacent to the injection canals 346 may be distorted by the high pressure of the plastic injected from the injecting holes 346.

Therefore, an improved injection mold and a new injection molding method are desired in order to overcome the above-described shortcomings.

### SUMMARY OF THE INVENTION

In one aspect thereof, an injection mold includes a female mold and a male mold. The female mold defines a recess portion therein. The male mold includes a mold core and defines at least one main injection canal therein. The mold core incorporates with the recess portion to form a cavity communicating with the main injection canal and configured for shaping workpieces. The main injection canal includes an injecting hole and an ejecting hole communicating with the injecting hole. The ejecting hole has a size larger than that of the injecting hole and is positioned to be proximate to the cavity.

In another aspect thereof, a method for shaping a workpiece, comprising the steps of: providing an injection mold which defines a cavity and at least one main injecting canal communicating with the cavity therein, the main injecting canal including an injecting hole and an ejecting hole communicating with the injecting hole, wherein the ejecting hole has a size larger than that of the injecting hole and is positioned to be proximate to the cavity; placing a film in the cavity; injecting melted plastic into the cavity via the main injecting canal to form a base; and forming a workpiece including the film and the base.

Other advantages and novel features will become more apparent from the following detailed description of the present embodiments when taken in conjunction with the accompanying drawings.

### BRIEF DESCRIPTION OF THE DRAWINGS

Many aspects of the present injection mold can be better identified with reference to the following drawings. The components in the drawing are not necessarily drawn to scale, the emphasis instead being placed upon clearly illustrating the principles of the injection mold. Moreover, in the drawing like reference numerals designate corresponding parts throughout the several drawings.

FIG. 1 is a disassembled, cross-sectional view of an injection mold in accordance with a present embodiment.

FIG. 2 is an assembled, cross-sectional view of the injection mold shown in FIG. 2.

FIG. 3 is a schematic view of an inner surface of a male mold of the injection mold shown in FIG. 1.

FIG. 4 is a disassembled view of a housing shaped by the injection mold shown in FIG. 1.

FIG. 5 is a schematic view of an inner surface of the housing shown in FIG. 4.

FIG. 6 is a cross-sectional view of attaching a film of the housing shown in FIG. 5 to the injection mold shown in FIG. 1.

FIG. 7 is a cross-sectional view of injecting plastic into the injection mold shown in FIG. 1.

FIG. 8 is a cross-sectional view of opening the injection mold shown in FIG. 1 after an injection molding operation.

FIG. 9 is a cross-sectional view of a typical injection mold.

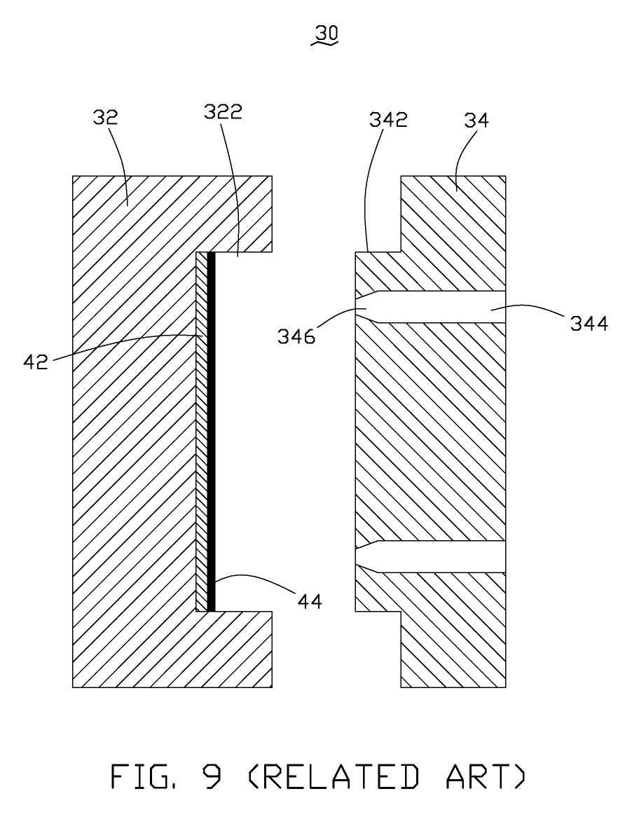

### DETAILED DESCRIPTION OF THE INVENTION

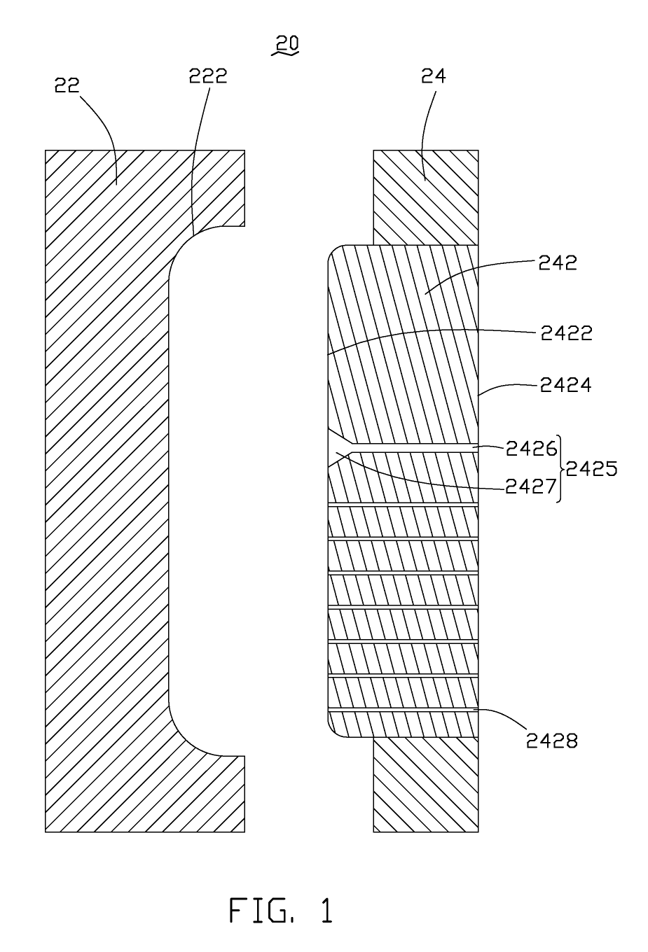

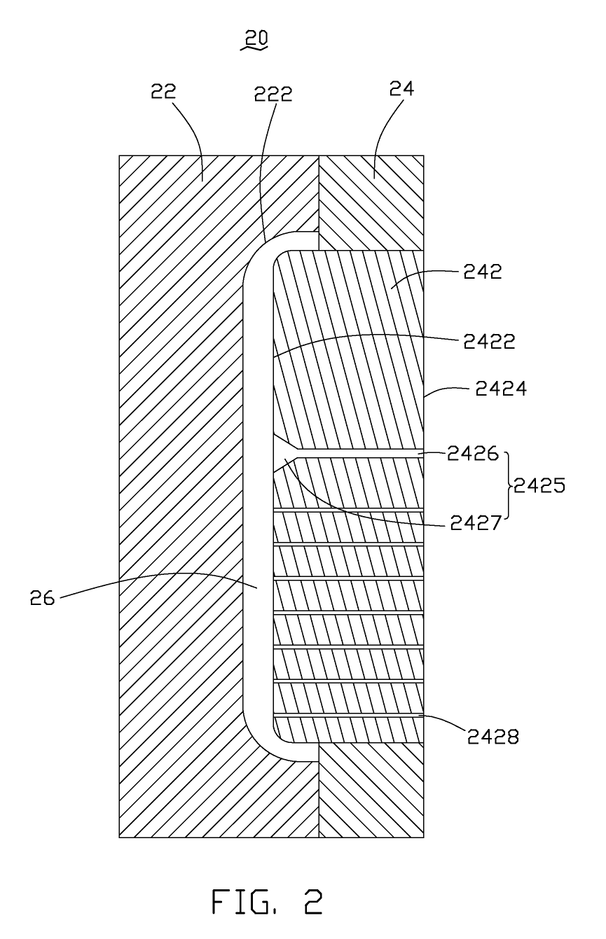

Referring to FIG. 1 and FIG. 2, an injection mold 20 in accordance with a present embodiment includes a female mold 22 and a male mold 24 matingly engageable with the female mold 22. The female mold 22 defines a recess portion 222 therein. The male mold 24 includes a mold core 242 corresponding to the recess portion 222. The mold core 242 cooperates with the recess portion 222 to form a cavity 26 configured for shaping workpieces such as housings of portable electronic device via injection molding.

The mold core 242 includes a first surface 2422 corresponding to the recess portion 222 and a second surface 2424 at an opposite side to the first surface 2422. The mold core 242 defines a main injection canal 2425 configured for injecting melted plastic therethrough, the first surface 2422 communicates with the second surface 2424 via the main injection canal 2425. Each main injection canal 2425 includes an injecting hole 2426 communicating with the second surface 2424 and an ejecting hole 2427 communicating with first surface 2422. The injecting hole 2426 is a cylindrical hole extending in a predetermined distance towards the second surface 2422 and communicating with the ejecting hole 2427 inside the mold core 242. A size of the ejecting hole 2427 gradually increases from its one end that communicates with the injecting hole 2426 to another end that communicates with the first surface 2422. Thus, the ejecting hole 2427 is configured to be horn-shaped. Understandably, the ejecting hole 2427 can be configured to be in other shapes having a size larger than that of the injecting hole 2426. The mold core 242 can also define a plurality of main injection canals 2425.

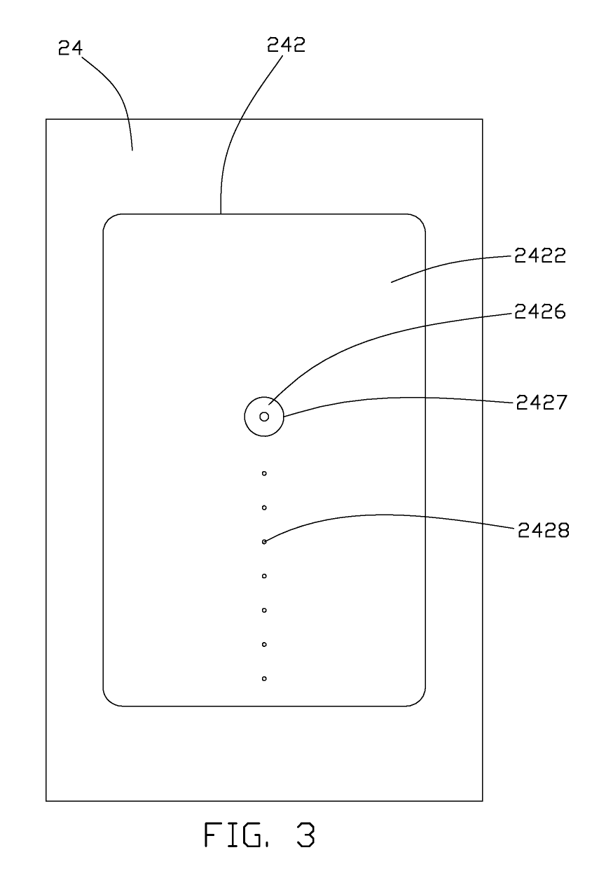

Also referring to FIG. 3, the mold core 242 also defines a plurality of subsidiary injection canals 2428 communicating the first surface 2422 with the second surface 2424 therein. Each subsidiary injection canal 2428 is a cylindrical hole, and a diameter of the subsidiary injection canal 2428 is less than that of the injecting hole 2426.

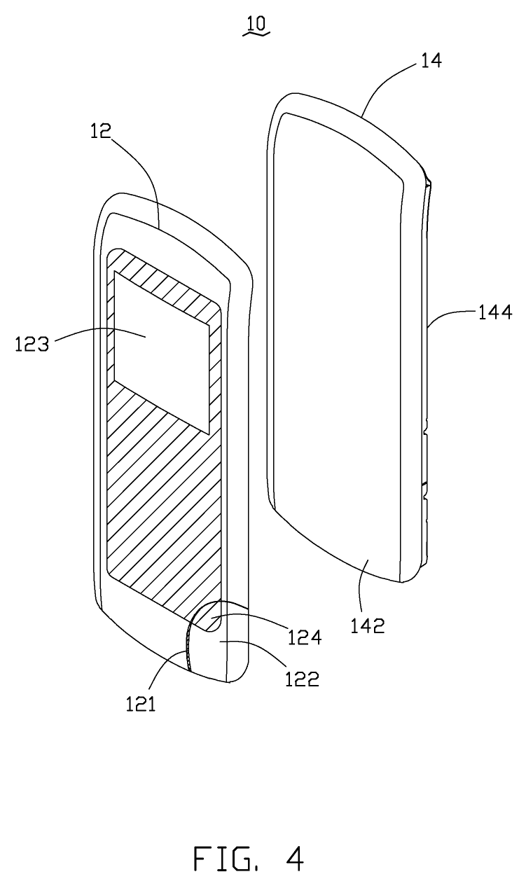

Referring to FIG. 4, a housing 10 shaped by the injection mold 20 is provided. The housing 10 is used in a portable electronic device, such as a mobile phone, and includes a film 12 and a base 14. Both the film 12 and the base 14 can, e.g., be made of materials chosen from a group consisting of polycarbonate, polymethyl methacrylate, polystyrene, acrylonitrile butadiene styrene, or any desired combination thereof.

The film 12 includes a transparent layer 121 and a shielding layer 122. The transparent layer 121 includes a display portion 123 formed on a middle portion thereof, and a decorating portion 124 formed by characters and designs made of ink or paint formed on an inner surface the transparent layer 121 and around the display portion 123. The shielding layer 122 can be made of ink, paint or metal film. The shielding layer 122 is formed on the inner surface of the transparent layer 121 except the display portion 123, thus the decorating portion 124 is enveloped between the transparent layer 121 and the shielding layer 122. Understandably, an area of the shielding layer 122 can also be decreased, thus the decorating portion 124 is partially exposed adjacent to the shielding layer 122. In this way, when the housing 10 is assembled on a portable electronic device, a display module of the portable electronic device is displayed through the display portion 123, and the decorating portion 124 decorates the portable electronic device.

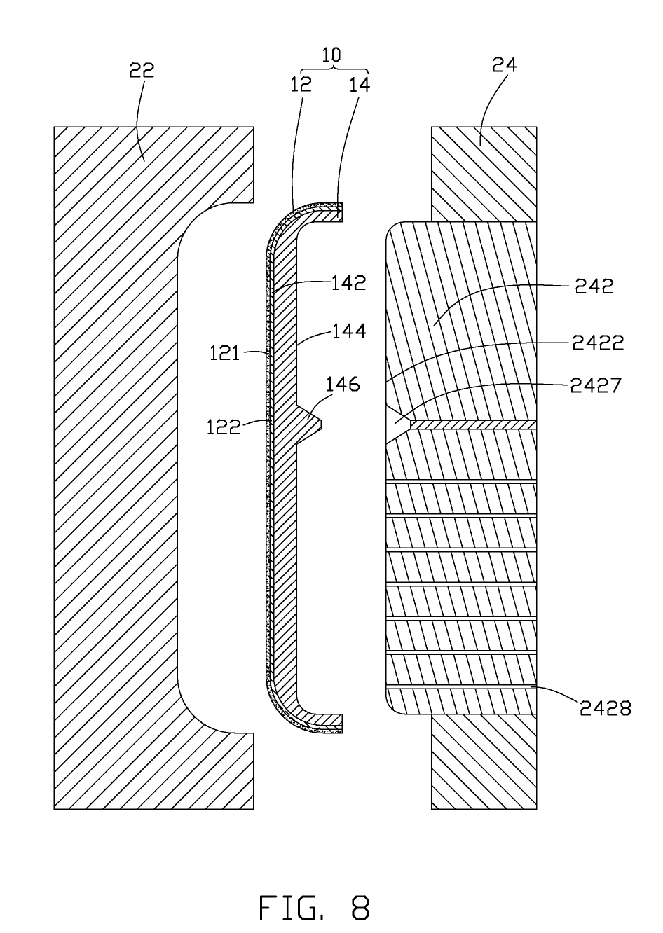

Also referring to FIG. 4 and FIG. 8, the base 14 includes an attaching surface 142, and a shaping surface 144 opposite to the attaching surface 142 and shaped by the mold core 242. The film 12 is attached to the attaching surface 142.

A method in accordance with a present embodiment is using the injection mold 20 to shape workpieces, such as an aforementioned housing 10. The method comprises these steps as follows.

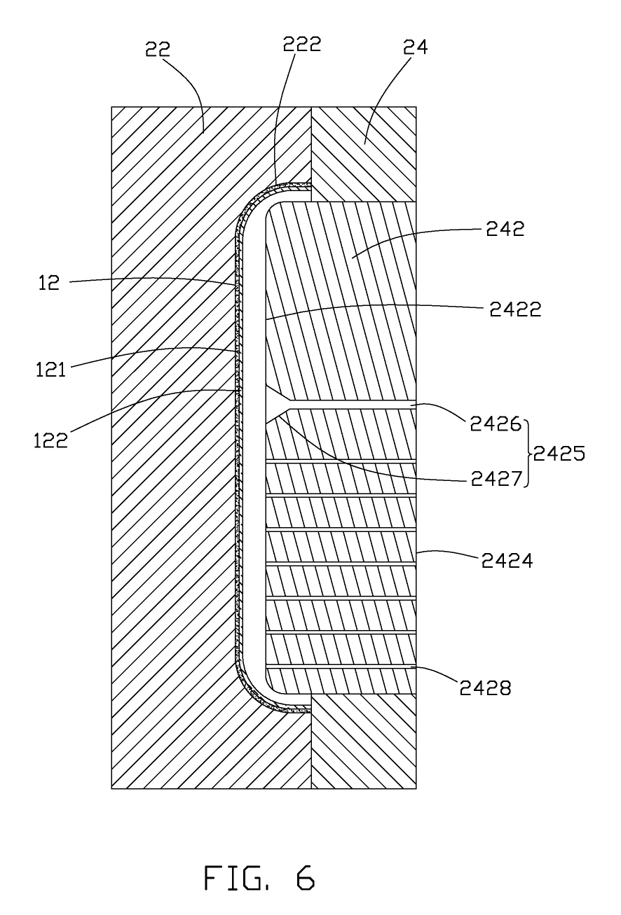

Referring to FIG. 6, an injection mold 20 is provided. An aforementioned film 12 is placed in the recess portion 222 of the female mold 22, and the shielding layer 122 is positioned towards the female mold 22. The male mold 24 and the female mold 22 are assembled together, thus the recess portion 222 of the female mold 22 cooperates with the first surface 2422 of the mold core 242 to form a cavity 26 corresponding to the shape and the size of the housing 10. In this way, the ejecting hole 2427 is positioned to be proximate to the cavity 26.

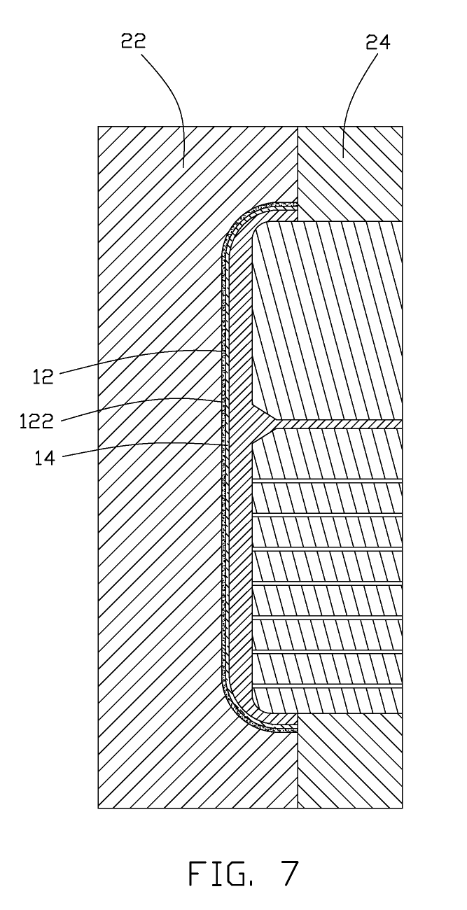

Also referring to FIG. 7, melted plastic is injected into the cavity 26 via the injecting hole 2426 of the main injection canal 2425. The melted plastic thus cools down to form the base 14, and the film 12 is attached on the attaching surface 142 of the base 14. In this way, the housing 10 is obtained.

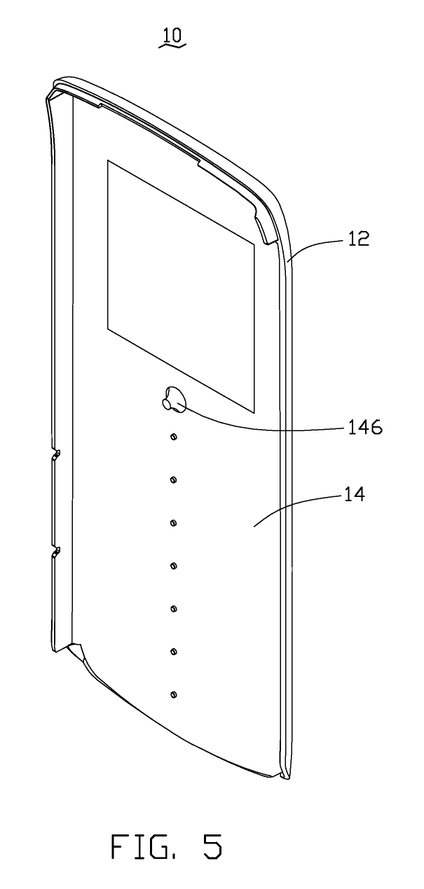

Also referring to FIG. 8, the injection mold 20 is opened after the injected plastic has cooled down, and the housing 10 comprising the film 12 and the base 14 is taken out. Also referring FIG. 5, a protrusion 146 corresponding to the ejecting hole 2427 may be formed on the shaping surface 144 of the base 14. Understandably, after the housing 10 is taken out, unwanted portions such as the protrusion 146 can be cut off to improve flatness of the housing 10.

Understandably, more main injection canals 2425 can also be defined in the mold core 242. When melted plastic is injected to the cavity 26 formed by the mold core 242 and the recess portion 222, the ejecting hole 2427 having a size larger than that of the injecting hole 2426 disperses the injected plastic, thus decreases pressure of the injected plastic and minimizes damage resulting from injected melted plastic with high pressure. In this way, the shielding layer 122 and/or the decorating portion 124 are prevented from being damaged by the injected melted plastic. The injecting hole 2426 can also be omitted, and the mold core 242 only defines at least one ejecting hole 2427 therethrough. Additionally, when the melted plastic is injected into the cavity 26 via the main injection canal 2426, it can also be simultaneously injected into the cavity 26 via the subsidiary injection canals 2428 for shaping the housing 10 more evenly.

It should be understood that even though numerous characteristics and advantages of the present embodiments have been set forth in the foregoing description, together with details of the structures and functions of the embodiments, the disclosure is for illustrative only, and changes may be made in detail, especially in matters of shape, size, and arrangement of parts within the principles of the invention. All such modification and variation are indicated to the full extent by the broad general meaning of the terms in which the appended claims are expressed.

What is claimed is:

1. An injection mold, comprising:
a female mold defining a recess portion therein, and
a male mold includes a mold core and defining at least one main injection canal therein, the mold core cooperating with the recess portion to form a cavity communicating with the main injection canal, the main injection canal including an injecting hole and an ejecting hole communicating with the injecting hole, wherein the ejecting hole has a size larger than that of the injecting hole and is positioned to be proximate to the cavity.

2. The injection mold as claimed in claim 1 wherein the mold core includes a first surface corresponding to the recess portion and a second surface opposite to the first surface, the main injection canal communicating the first surface with the second surface.

3. The injection mold as claimed in claim 2, wherein the injecting hole communicates with the second surface and the ejecting hole communicates with first surface.

4. The injection mold as claimed in claim 3, wherein a diameter of the ejecting hole gradually increases from its one end that communicates with the injecting hole to another end that communicates with the first surface.

5. The injection mold as claimed in claim 1, wherein the male mold defines a plurality of subsidiary injection canals therein.

6. The injection mold as claimed in claim 5, wherein each subsidiary injection canal is configured to be a cylindrical hole, and a diameter of the subsidiary injection canal is configured to be less than that of the injecting hole.

7. A method for shaping a workpiece, comprising the steps of:
providing an injection mold which defines a cavity and at least one main injecting canal communicating with the cavity therein, the main injecting canal including an injecting hole and an ejecting hole communicating with the injecting hole, wherein the ejecting hole has a size larger than that of the injecting hole and is positioned to be proximate to the cavity;
placing a film in the cavity;
injecting melted plastic into the cavity via the main injecting canal to form a base; and
forming a workpiece including the film and the base.

8. The method as claimed in claim 7, further comprising a step of cutting off an unwanted portion of a workpiece after the step of forming a workpiece including the film and the base.

9. The method as claimed in claim 7, further comprising a step of simultaneously injecting melted plastic into the cavity via a plurality of subsidiary injection canals defined in the injection mold when performing the step of injecting melted plastic into the cavity via the main injecting canal to form a base.
